(19) United States
(12) Patent Application Publication
(10) Pub. No.: US 2013/0283280 A1
(43) Pub. Date: Oct. 24, 2013

(54) METHOD TO REDUCE MULTI-THREADED PROCESSOR POWER CONSUMPTION

(71) Applicant: QUALCOMM INCORPORATED, San Diego, CA (US)

(72) Inventors: Steven D. Cheng, San Diego, CA (US); Gurvinder Singh Chhabra, San Diego, CA (US)

(73) Assignee: QUALCOMM Incorporated, San Diego, CA (US)

(21) Appl. No.: 13/762,587

(22) Filed: Feb. 8, 2013

Related U.S. Application Data
(60) Provisional application No. 61/636,370, filed on Apr. 20, 2012.

(51) Int. Cl. G06F 9/48

(52) U.S. Cl. CPC G06F 9/4893
USPC 718/102

(57) ABSTRACT

Aspects of the disclosure generally relate to methods and apparatus for wireless communication. In an aspect, a method for dynamically processing data on interleaved multithreaded (MT) systems is provided. The method generally includes monitoring loading on one or more active processor threads, determining whether to remove a task or create an additional task based on the monitored loading of the one or more active processor threads and a number of tasks running on one or more of the one or more active processor threads, and if a determination is made to remove a task or create an additional task, distributing the resulting tasks among one or more available processor threads.

### CLAIM OF PRIORITY UNDER 35 U.S.C. §119

The present Application for Patent claims priority to U.S. Provisional Application No. 61/636,370, filed Apr. 20, 2012, and assigned to the assignee hereof, which is hereby expressly incorporated by reference herein.

### BACKGROUND

1. Field

Certain aspects of the present disclosure generally relate to wireless communications and, more particularly, to methods and apparatus for dynamic processing of data tasks on multi-threaded systems.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and superior integration with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Orthogonal frequency-division multiplexing (OFDM) and orthogonal frequency division multiple access (OFDMA) wireless communication systems use a network of base stations to communicate with wireless devices (e.g., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations. For various reasons, such as a mobile station (MS) moving away from the area covered by one base station and entering the area covered by another, a handover (also known as a handoff) may be performed to transfer communication services (e.g., an ongoing call or data session) from one base station to another.

In some cases, an MS may utilize a scalable, multi-threaded (MT) processor to that has multiple identical processing units with shared (e.g., L2 cache) memory to cut down on processing latency. The MT architecture may become more desirable and attractive as the data rate provided by all of the wireless standards keeps increasing. Unfortunately, power consumption in an MT architecture is much higher than the traditional single threaded architecture because of the extra hardware components.

### SUMMARY

In an aspect of the disclosure, a method for dynamically processing data is provided. The method generally includes monitoring loading on one or more active processor threads, determining whether to remove a task or create an additional task based on the monitored loading of the one or more active processor threads and a number of tasks running on one or more of the one or more active processor threads, and distributing the resulting tasks among one or more available processor threads if a determination is made to remove a task or create an additional task.

In an aspect of the disclosure, a method for completing a workload on a multithreaded system using dynamic tasks is provided. The method generally includes monitoring loading on one or more active processor threads, determining whether to remove a task or create an additional task based on the monitored loading of the one or more active processor threads and a number of tasks running on one or more of the one or more active processor threads associated with the workload, and distributing the workload across tasks executing on separate processor threads if determination resulted in more than one task being associated with the workload.

In an aspect of the disclosure, an apparatus for dynamically processing data is provided. The apparatus generally includes means for monitoring loading on one or more active processor threads, means for determining whether to remove a task or create an additional task based on the monitored loading of the one or more active processor threads and a number of tasks running on one or more of the one or more active processor threads, and means for distributing the resulting tasks among one or more available processor threads if a determination is made to remove a task or create an additional task.

In an aspect of the disclosure, an apparatus for completing a workload on a multithreaded system using dynamic tasks is provided. The apparatus generally includes means for monitoring loading on one or more active processor threads, means for determining whether to remove a task or create an additional task based on the monitored loading of the one or more active processor threads and a number of tasks running on one or more of the one or more active processor threads associated with the workload, and means for distributing the workload across tasks executing on separate processor threads if determination resulted in more than one task being associated with the workload.

In an aspect of the disclosure, an apparatus for dynamically processing data is provided. The apparatus generally includes at least one processor configured to monitor loading on one or more active processor threads, determine whether to remove a task or create an additional task based on the monitored loading of the one or more active processor threads and a number of tasks running on one or more of the one or more active processor threads, and distribute the resulting tasks among one or more available processor threads if a determination is made to remove a task or create an additional task; and a memory coupled with the at least one processor.

In an aspect of the disclosure, an apparatus for completing a workload on a multithreaded system using dynamic tasks is provided. The apparatus generally includes at least one processor configured to monitor loading on one or more active processor threads, determine whether to remove a task or create an additional task based on the monitored loading of the one or more active processor threads and a number of tasks running on one or more of the one or more active processor threads associated with the workload, and distribute the workload across tasks executing on separate processor threads if determination resulted in more than one task being associated with the workload; and a memory coupled with the at least one processor.

In an aspect of the disclosure, computer program product for dynamically processing data, comprising a computer-readable medium having instructions stored thereon is provided. The instructions are generally executable by one or more processors for monitoring loading on one or more active processor threads, determining whether to remove a task or create an additional task based on the monitored loading of the one or more active processor threads and a number of tasks running on one or more of the one or more active processor threads, and distributing the resulting tasks among one or more available processor threads if a determination is made to remove a task or create an additional task.

In an aspect of the disclosure, computer program product for completing a workload on a multithreaded system using dynamic tasks, comprising a computer-readable medium having instructions stored thereon is provided. The instructions are generally executable by one or more processors for monitoring loading on one or more active processor threads, determining whether to remove a task or create an additional task based on the monitored loading of the one or more active processor threads and a number of tasks running on one or more of the one or more active processor threads associated with the workload, and distributing the workload across tasks executing on separate processor threads if determination resulted in more than one task being associated with the workload; and a memory coupled with the at least one processor.

Numerous other aspects including apparatus, systems, computer program products, and processing systems are provided.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain aspects of the present disclosure.

FIG. 2 illustrates example components that may be utilized in a wireless device, in accordance with certain aspects of the present disclosure.

FIG. 3 is a diagram illustrating an example of an evolved Node B and user equipment in an access network, in accordance with certain aspects of the present disclosure.

FIG. 4 is a chart illustrating example multi-threaded processor performance in accordance with this disclosure.

FIG. 5 is a chart illustrating example multi-threaded processor all-waits percentages for a processor operating at various configurations.

FIG. 6 illustrates example operations for processing data with a multithreaded processor, in accordance with certain aspects of the present disclosure

FIG. 7 illustrates an example multi-threaded modem sub-system, in accordance with this disclosure.

FIGS. 8A-8C illustrate an example sequence of operations of a multi-threaded modem sub-system, in accordance with the present disclosure.

FIG. 9 illustrates example performance of a multi-threaded processor operated in accordance with the present disclosure.

### DETAILED DESCRIPTION

Certain aspects of the present disclosure provide methods for reducing power consumption associated with a multi-threaded processor of a mobile station (MS) modem sub-system. According to aspects, a processing control unit may configure a multi-threaded processor to create power savings in an efficient and dynamic manner based on monitored data rates. The processing control unit may configure the multi-threaded processor by employing processes involving one or more of the steps of adjusting the processor clock frequency, activating or deactivating processor hardware threads, or buffering data and reprocessing it at a later time.

### An Example Wireless Communication System

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

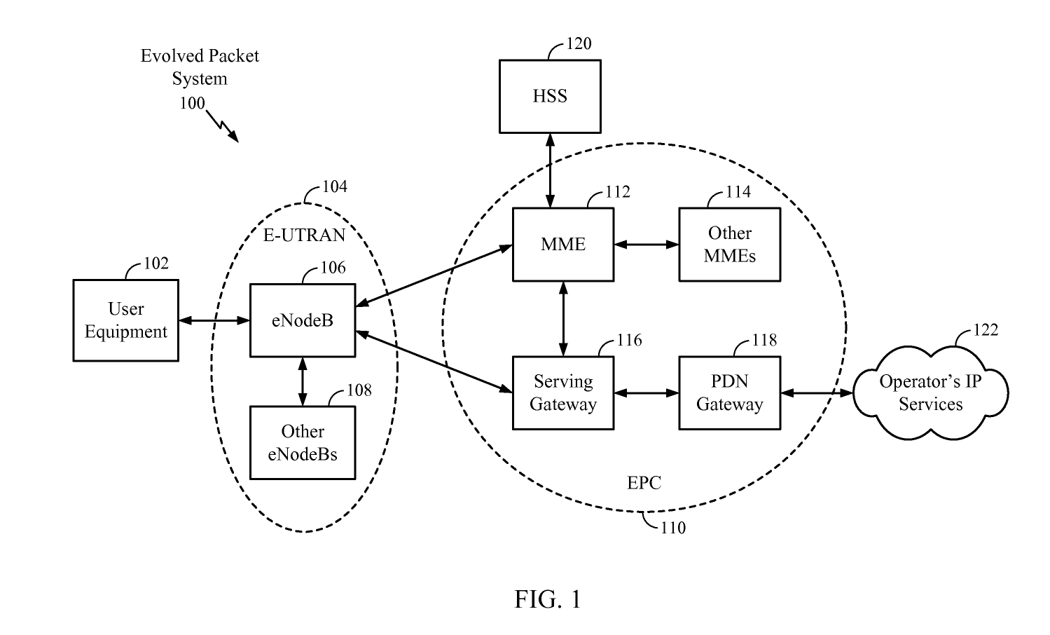

FIG. 1 illustrates an example wireless communication system, in accordance with certain aspects of the present disclosure. The wireless communication system may employ an LTE network architecture 100. The LTE network architecture 100 may be referred to as an Evolved Packet System (EPS) 100. The EPS 100 may include one or more user equipment (UE) 106, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

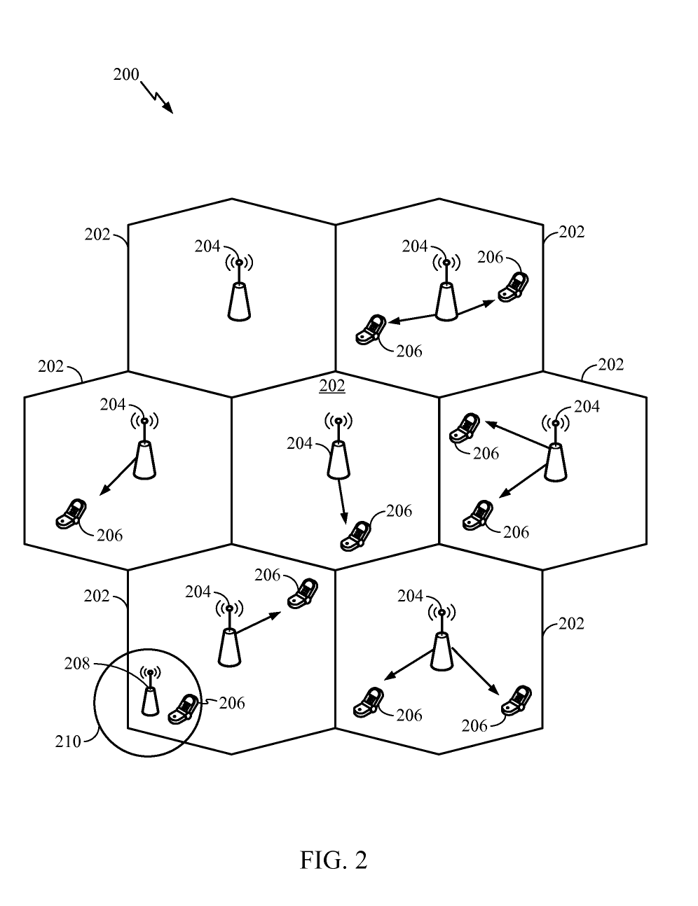

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

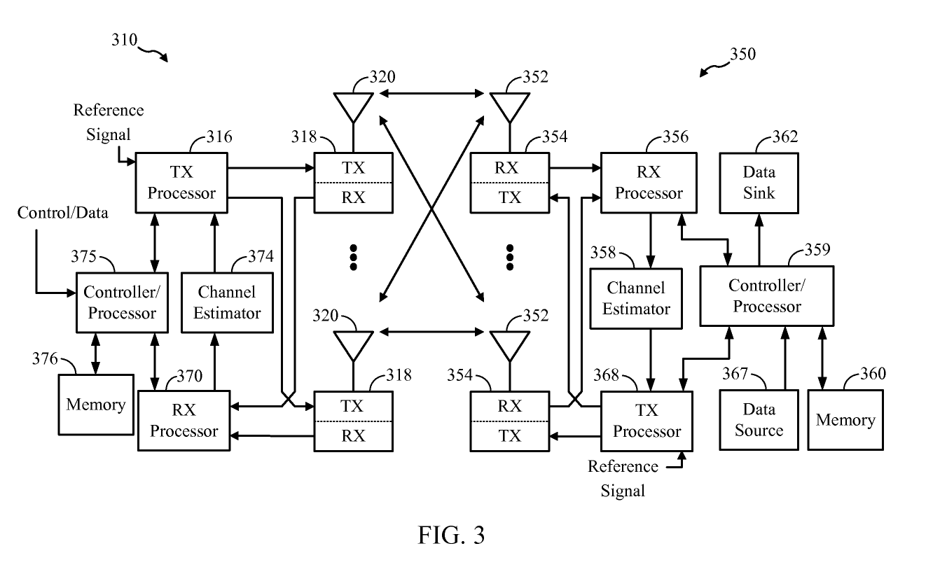

FIG. 3 is a block diagram of an eNB 310 in communication with a UE 350 in an access network. In the DL, upper layer packets from the core network are provided to a controller/processor 375. The controller/processor 375 implements the functionality of the L2 layer. In the DL, the controller/processor 375 provides header compression, ciphering, packet segmentation and reordering, multiplexing between logical and transport channels, and radio resource allocations to the UE 350 based on various priority metrics. The controller/processor 375 is also responsible for HARQ operations, retransmission of lost packets, and signaling to the UE 350.

The TX processor 316 implements various signal processing functions for the L1 layer (e.g., physical layer). The signal processing functions includes coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream is then provided to a different antenna 320 via a separate transmitter 318TX. Each transmitter 318TX modulates an RF carrier with a respective spatial stream for transmission.

At the UE 350, each receiver 354RX receives a signal through its respective antenna 352. Each receiver 354RX recovers information modulated onto an RF carrier and provides the information to the receiver (RX) processor 356. The RX processor 356 implements various signal processing functions of the L1 layer. The RX processor 356 performs spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the control/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations.

In the UL, a data source 367 is used to provide upper layer packets to the controller/processor 359. The data source 367 represents all protocol layers above the L2 layer. Similar to the functionality described in connection with the DL transmission by the eNB 310, the controller/processor 359 implements the L2 layer for the user plane and the control plane by providing header compression, ciphering, packet segmentation and reordering, and multiplexing between logical and transport channels based on radio resource allocations by the eNB 310. The controller/processor 359 is also responsible for HARQ operations, retransmission of lost packets, and signaling to the eNB 310.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 are provided to different antenna 352 via separate transmitters 354TX. Each transmitter 354TX modulates an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the L1 layer.

The controller/processor 375 implements the L2 layer. The controller/processor 375 can be associated with a memory 376 that stores program codes and data. The memory 376 may be referred to as a computer-readable medium. In the UL, the control/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

### Example Techniques for Reducing Multi-Threaded Processor Power Consumption

Techniques presented herein are described with reference to mutli-threaded processor systems in a mobile phone or user equipment (UE) environment as an example application only. Those skilled in the art, however, will recognize the techniques presented herein may be applied any type of system with multiple processing units.

With increasing data rate requirements specified by wireless standards, inter-leaved multi-threaded (MT) systems have been preferred over traditional single-threaded systems in wireless modem architecture for their scalability, size, and cost. Such systems distribute software processing tasks among multiple hardware processing units.

In some cases, a mobile device (MS or UE) may include a “modem-centric” wireless modem to support the wireless modem related features. In other words, these components may support wireless applications in an exclusive way, without handling other tasks.

Due to the scalability described above, MT-processors (e.g., with multi-threaded or interleaved multi-threaded MT hardware architecture) may be used in modem-centric wireless modems. Their scalable architecture may provide an easy solution to software and product development, making it easy to accommodate the different MIPS consumption required by different data rates.

Traditionally, MT-processor based architectures were not used in wireless communications when older generation networks (e.g., 1G and 2G) were dominant Single-threaded architectures were used almost exclusively at that time because the data rate did not increase much among this evolution. However, as data rates increase, the traditional single-threaded architecture is proving insufficient in terms of size and cost. Consequently, MT-processor based architectures become more desirable and attractive as the data rate provided by wireless standards keeps increasing.

Compared to traditional single-threaded architectures, MT architectures may be especially well-suited for high data rate use cases. As a result, however, power consumption for the MT architecture may be much higher than the traditional single-threaded processors because of the extra hardware components.

Because the use of wireless devices is frequently limited by their available battery power, how to reduce the power consumption becomes one of the challenging topics in wireless product design. Currently, multi-threaded architecture designs which support 4G, and also support 2G and 3G, may consume more power when compared with a single thread architecture in the same use case.

The efficient use of available processor threads to achieve peak data rates while meeting the demand for lower power consumption on mobile devices is a challenging topic in modern design.

Techniques of the present disclosure may help address this challenge by providing a flexible architecture that may be re-configured based on data rate. As will be described in greater detail below, an MT-processor may be configured with a clock rate and number of active threads suitable to accommodate a given data rate. As data rate increases, the MT-processor may be reconfigured with a higher clock rate and/or a greater number of active threads. In this manner, the MT-processor may only consume additional power as needed to process an increase in data rate. Similarly, as the data rate decreases, clock rate and/or the number of active threads may be reduced to help reduce power consumption.

An example architecture for a modem subsystem in which aspects of the present disclosure may be practiced may include processing control logic that monitors data rate of uplink data and downlink data. As will be described in greater detail below, the control logic may reconfigure an MT processor, based on the monitored data rate(s), for example, by adjusting a clock rate and/or number of active processing threads.

Incrementally adjusting processing rate in this manner (by adjusting clock rate and/or the number of active threads) may be desirable to reduce power consumption in MT architectures. This approach may be effective with architectures originally designed to accommodate the maximum data rate use cases, as defined in these 4G standards. In a typical data transfer scenario, the 4G network will never grant all of the air resource to one customer, so most of the time each active mobile device sharing the same base station will only be assigned a small portion of air resource and this portion is also very dynamic.

Analysis has shown that different values of data rate consume different MIPS (million instructions per second). The more HW threads are activated in an MT-based architecture, the more MIPS can be provided. However, the all-waits percentage achieved may vary with the number of HW threads and the amount of parallelism observed. The all-waits refers to all of the HW threads inside an MT-based architecture are all idle. When an MT-based architecture is in all-waits state, the processor can perform the shallow sleep by shutdown a major portion of the circuitry immediately. As a result, in order to achieve a better power saving result through the all-waits approach, the processing capability should be proportional to the processed data rate. In order to assess the instant UL and DL data rate, the observation points are planted into the data paths to assess the data rate. Without readjusting the instant data rate using the appropriate processing rate, more battery power will be consumed

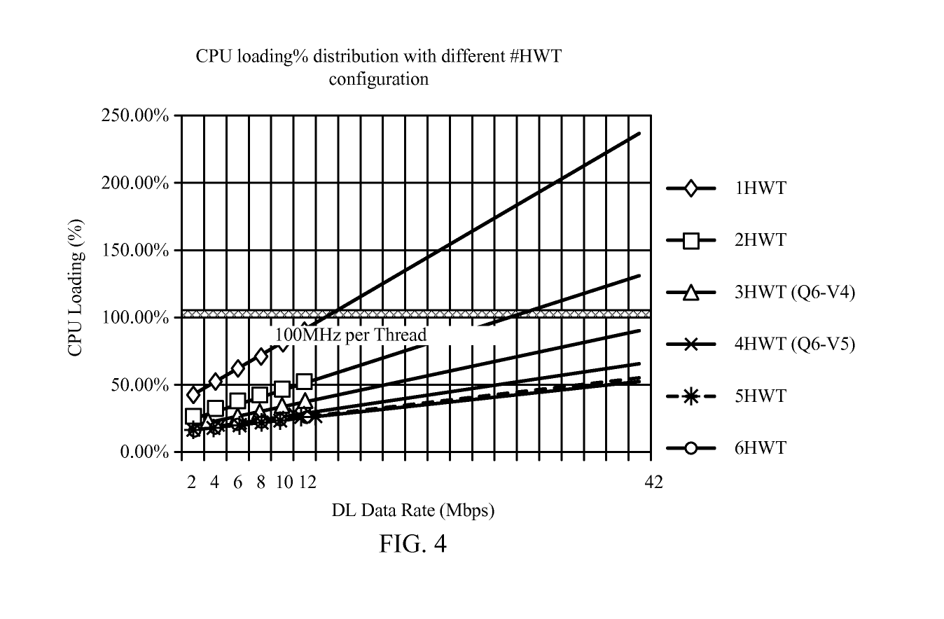

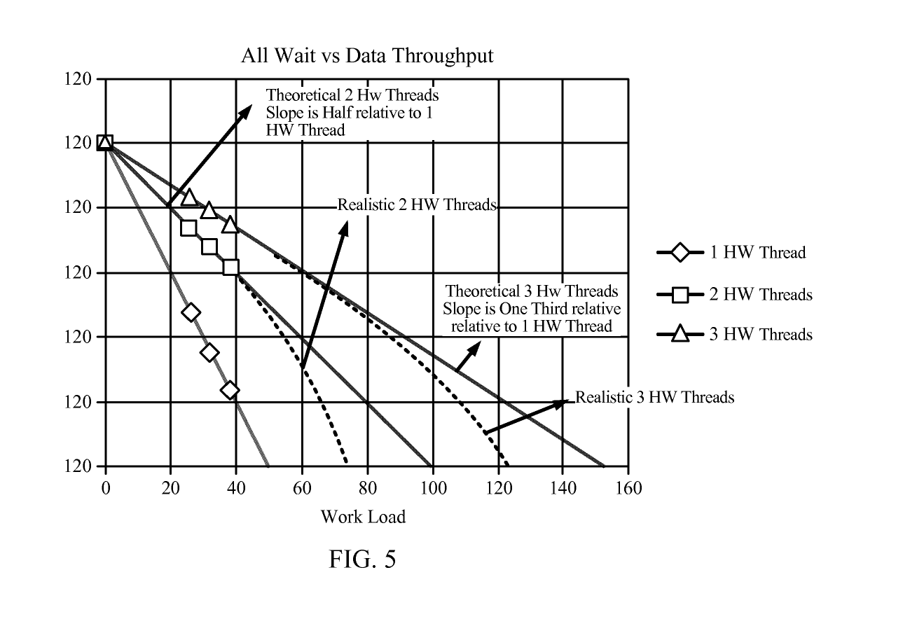

FIG. 4, however, illustrates how an MT architecture may be reconfigured using a subset of HW threads and how the MIPS supported by the different configurations changes. FIG. 5, illustrates how the MT architecture may be reconfigured using different number of HW threads, and how the percentage of “all-waits” states may be different. In general, the all-waits states may decide whether an MT architecture can perform shallow sleep immediately. As illustrated in FIG. 5, in general, the all-waits percentage may be better with more than one active HW thread should be better than with a single Active HW thread.

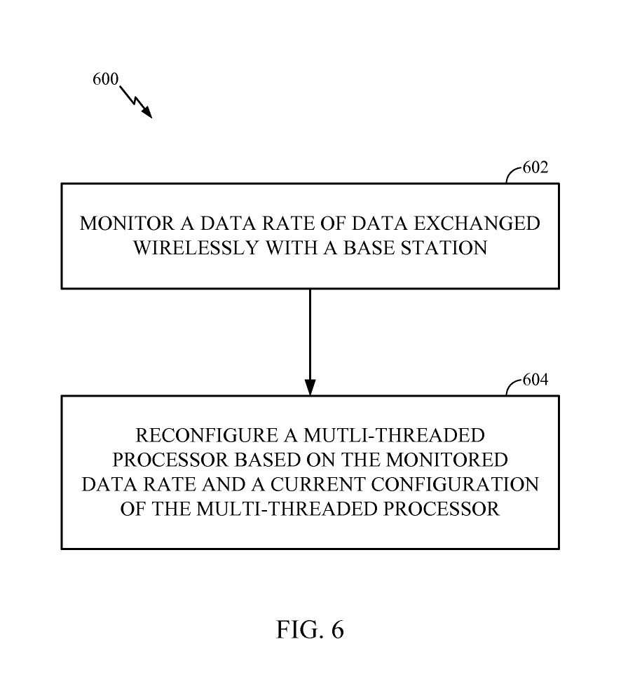

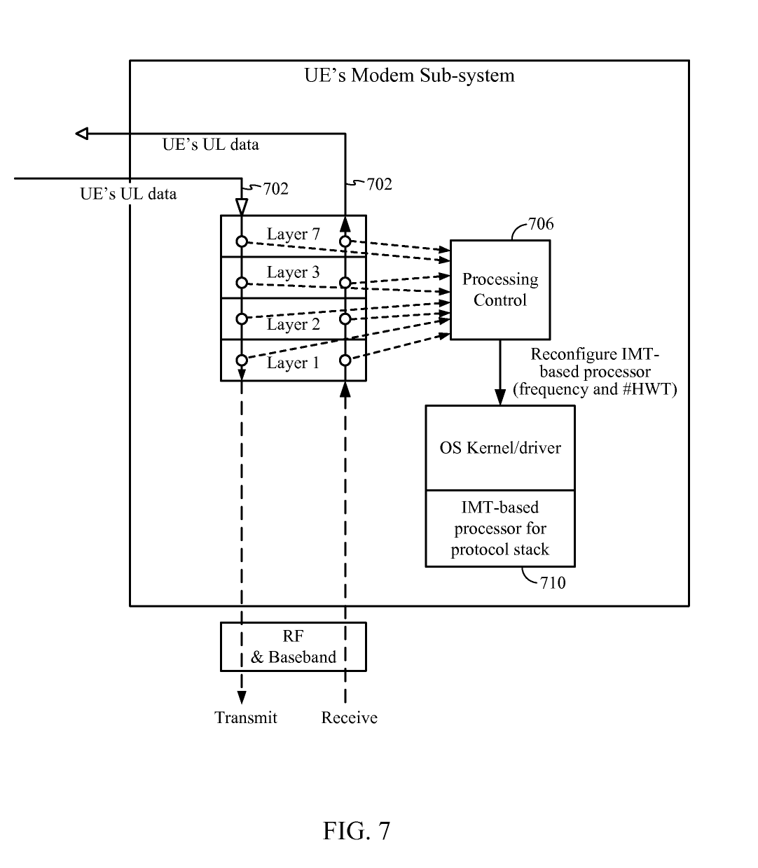

FIG. 6 illustrates example operations 600 that may be performed by a user equipment utilizing a MT-based architecture. The operations 600 may be performed, for example, by processor logic 706 in the example architecture shown in FIG. 7, to reconfigure a multi-threaded processor in accordance with aspects of the present disclosure.

The operations 600 begin, at 602, by monitoring a data rate of data (e.g., uplink and/or downlink data) exchanged wirelessly with a base station. At 604, a multi-threaded processor is reconfigured based on the monitored data rate and the current configuration of the processor

As illustrated in FIG. 7, some observation points may be activated in both the UL data path (702) and DL data path (704) of a given protocol stack, and may be located at different layers (e.g., layers 1, 2, 3, or 7). Each observation point may provide associated data rate information processing control logic 706 may use when deciding how to (or whether to) reconfigure the MT processor 710.

The processing control unit may be used to adjust the processed data rate based upon the incoming data rate. As illustrated, an interface may be established between the protocol stack and the processing control unit using the observation points, so the incoming data rate information can be passed to the processing control unit when needed. An interface may also be established between the OS kernel and HW driver and the flow control unit, so the processing control unit can configure the MT-based architecture processing capability when needed. The processing control unit may operate to perform reconfiguration based on different data rates from different standards to adjust the MT-based architecture processing capability accordingly.

An example procedure that may be implemented in a UE is described herein. As a first step, an active RAT may be assigned. Once the active RAT is assigned, the data rate supported by a given number of HW threads and clock rate may be decided. The processing control unit may then be initialized when a data call is established.

Once the processing control unit is initialized, a regulated data rate may also be initialized. In the initial state, only 1 or 2 hardware threads may be active, with a relatively low processor clock rate. The processing control unit may then continue to monitor the UL and DL data rate.

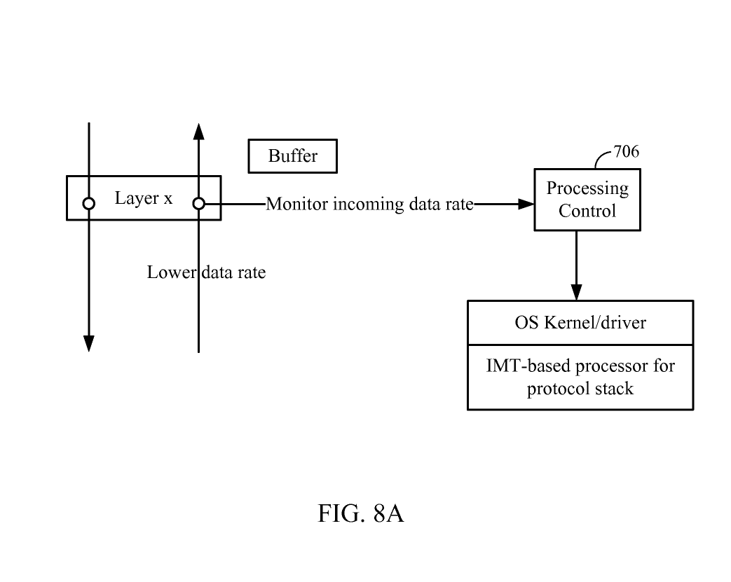

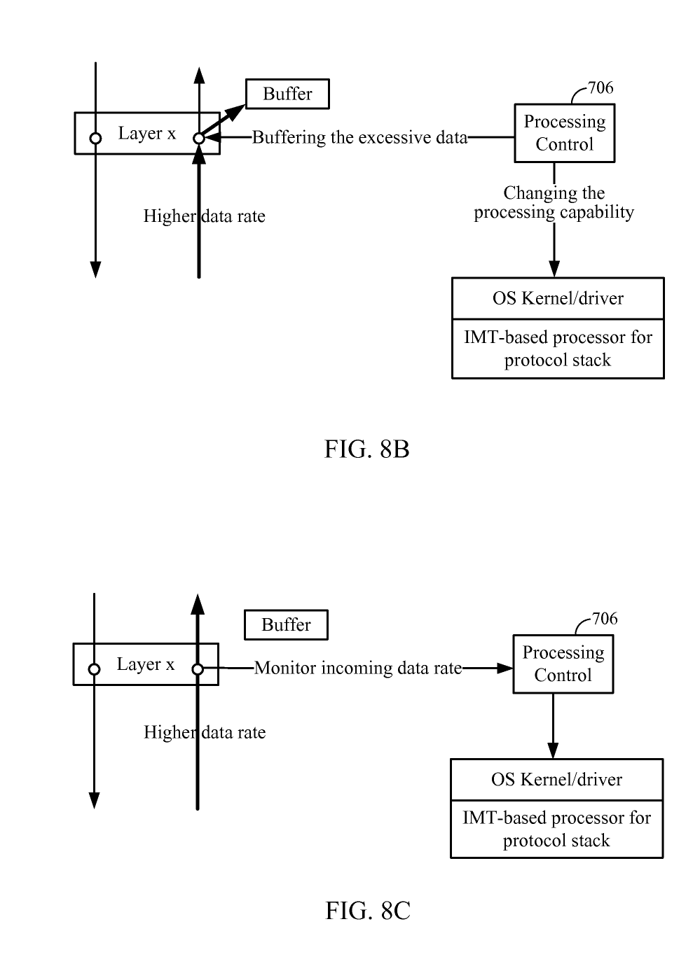

As illustrated in FIG. 8A, at an initial configuration, the MT processor may be able to handle a relatively lower data rate.

As data rate increases to a higher rate, as shown in FIG. 8B, the processing control logic may reconfigure the MT-based processor, for example by increasing clock rate first and, if a maximum clock rate is reached, activating an additional thread and decreasing clock rate. As shown in FIG. 8C, the subsystem may be able to sustain the higher data rate (e.g., without reconfiguration unless the data rate continues to increase).

During a transition between configurations, if a current processing configuration is unable to process the incoming data in time, a local buffer may be used-as shown in FIGS. 8A-8C, so no data will be lost. Data in the buffer (along with other incoming data) may be re-processed at the new configuration.

As illustrated, if the incoming data rate changes and becomes heavier than the current maximal processing rate that can be handled, the processing control unit will buffer the extra data and increase the processor clock rate and then reprocess the buffered data and the incoming data. If the processor clock rate is increased to a maximal value, the processing control unit will activate one new HW thread and lower the processor clock rate, and then reprocess the buffered data and the incoming data.

In a similar manner, if the incoming data rate changes and becomes less heavy, the processing control unit will decrease the processor clock rate and reprocess the incoming data; if the processor clock rate is decreased to a minimal value, the processing control unit will deactivate one existing HW thread and increase the processor clock rate, and then reprocess the incoming data. A reset of the processing control unit may occur, for example, when a data call is dropped.

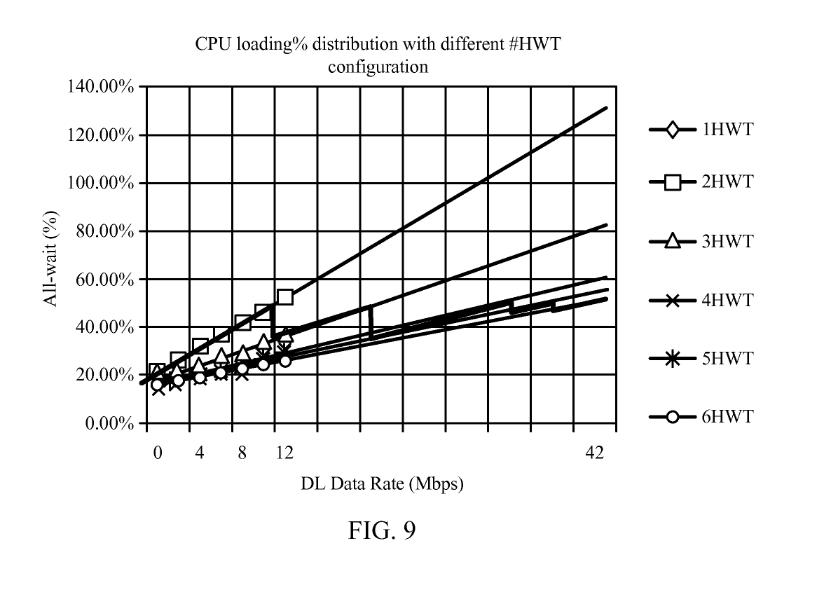

FIG. 9 illustrates an example impact of controlling an MT architecture in accordance with aspects of the present disclosure. As illustrated, the system may be initialized with 2 active threads, and may be capable of processing exchanged data at a rate of 1 Mbps. As the data rate increases (e.g., up to 42 Mbps or beyond), the processing control unit may iteratively increase clock rate and increase processing threads, as described above, such that power is only used when necessary. The figure illustrates different data rate thresholds, at which a reconfiguration may take place to use a different number of HW threads.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by various hardware and/or software component(s) and/or module(s) corresponding to means-plus-function blocks illustrated in the Figures. More generally, where there are methods illustrated in Figures having corresponding counterpart means-plus-function Figures, the operation blocks correspond to means-plus-function blocks with similar numbering.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for dynamically processing data, comprising:
monitoring loading on one or more active processor threads;
determining whether to remove a task or create an additional task based on the monitored loading of the one or more active processor threads and a number of tasks running on one or more of the one or more active processor threads; and
if a determination is made to remove a task or create an additional task, distributing the resulting tasks among one or more available processor threads.

2. The method of claim 1, wherein the determining comprises:
determining to remove a task if loading of a processor thread is below a first threshold value and the number of tasks associated with the processor thread is greater than one; or
determining to create an additional task if loading of a processor thread is above a second threshold value and the number of tasks is less than a number of available processor threads.

3. The method of claim 1, further comprising synchronizing the output from the tasks.

4. The method of claim 1, wherein the monitoring comprises placing an observation point along a datapath of the system.

5. The method of claim 4, wherein the observation point is in at least one of the network protocol layers.

6. The method of claim 2, wherein the first and second thresholds are selected such as to avoid toggling between creating and removing a task by selecting a first threshold that is less than half of the second threshold.

7. The method of claim 1, wherein monitoring is performed at a specified periodicity.

8. The method of claim 1, wherein distributing the resulting tasks among the available processor threads comprises dividing packets and the corresponding computations among the one or more available processor threads.

9. The method of claim 8, wherein dividing packets and the corresponding computations among the one or more available processor threads includes increasing a data throughput rate.

10. The method of claim 2, wherein synchronizing the output from the tasks comprises the use of a re-ordering buffer to re-organize output data packets from each task into the same order as in a single task model.

11. The method of claim 1, further comprising:
determining that at least one of the one or more processor threads has become idle; and
powering down the at least one idle processor thread.

12. A method for processing tasks, comprising:
monitoring loading on one or more active processor threads;
determining whether to remove a task or create an additional task based on the monitored loading of the one or more active processor threads and a number of tasks running on one or more of the one or more active processor threads associated with the workload; and
distributing the workload across tasks executing on separate processor threads if determination resulted in more than one task being associated with the workload.

13. The method of claim 12, wherein the determining comprises:
determining to remove a task if loading of a processor thread is below a first threshold value and the number of tasks associated with the workload is greater than one; or
determining to create an additional task if loading of a processor thread is above a second threshold value and the number of tasks associated with the workload is less than a number of available processor threads.

14. The method of claim 12, further comprising synchronizing the output from the tasks.

15. The method of claim 12, wherein the monitoring comprises placing an observation point along a datapath of the system.

16. The method of claim 15, wherein the observation point is in at least one of the network protocol layers.

17. The method of claim 13, wherein the first and second thresholds are selected such as to avoid toggling between creating an additional task and removing a task by selecting a first threshold that is less than half of the second threshold.

18. The method of claim 12, wherein monitoring is performed at a specified periodicity.

19. The method of claim 12, wherein distributing the resulting tasks among the available processor threads comprises dividing packets and the corresponding computations among the one or more available processor threads.

20. The method of claim 19, wherein dividing packets and the corresponding computations among the one or more available processor threads includes increasing the workload parallelism, potentially facilitating a higher data throughput rate.

21. The method of claim 13, wherein synchronizing the output from the tasks comprises the use of a re-ordering buffer to re-organize output data packets from each task into the same order as in a single task model.

22. The method of claim 12, further comprising:
determining that at least one of the one or more processor threads has become idle; and
powering down the at least one idle processor thread.

23. An apparatus for dynamically processing data, comprising:
means for monitoring loading on one or more active processor threads;
means for determining whether to remove a task or create an additional task based on the monitored loading of the one or more active processor threads and a number of tasks running on one or more of the one or more active processor threads; and
means for distributing the resulting tasks among one or more available processor threads if a determination is made to remove a task or create an additional task.

24. An apparatus for dynamically processing data, comprising:
means for monitoring loading on one or more active processor threads;
means for determining whether to remove a task or create an additional task based on the monitored loading of the one or more active processor threads and a number of tasks running on one or more of the one or more active processor threads associated with the workload; and
means for distributing the workload across tasks executing on separate processor threads if determination resulted in more than one task being associated with the workload.

25. An apparatus for dynamically processing data, comprising:
at least one processor configured to monitor loading on one or more active processor threads, determine whether to remove a task or create an additional task based on the monitored loading of the one or more active processor threads and a number of tasks running on one or more of the one or more active processor threads, and distribute the resulting tasks among one or more available processor threads if a determination is made to remove a task or create an additional task; and
a memory coupled with the at least one processor.

26. An apparatus for dynamically processing data, comprising:
at least one processor configured to monitor loading on one or more active processor threads, determine whether to remove a task or create an additional task based on the monitored loading of the one or more active processor threads and a number of tasks running on one or more of the one or more active processor threads associated with the workload, and distribute the workload across tasks executing on separate processor threads if determination resulted in more than one task being associated with the workload; and
a memory coupled with the at least one processor.

27. A computer program product for dynamically processing data, comprising a computer-readable medium having instructions stored thereon, the instructions executable by one or more processors for:
monitoring loading on one or more active processor threads;
determining whether to remove a task or create an additional task based on the monitored loading of the one or more active processor threads and a number of tasks running on one or more of the one or more active processor threads; and
distributing the resulting tasks among one or more available processor threads if a determination is made to remove a task or create an additional task.

28. A computer program product for dynamically processing data, comprising a computer-readable medium having instructions stored thereon, the instructions executable by one or more processors for, comprising:
monitoring loading on one or more active processor threads;
determining whether to remove a task or create an additional task based on the monitored loading of the one or more active processor threads and a number of tasks running on one or more of the one or more active processor threads associated with the workload; and
distributing the workload across tasks executing on separate processor threads if determination resulted in more than one task being associated with the workload.
